(19) United States
(12) Patent Application Publication
(10) Pub. No.: US 2020/0402032 A1
(43) Pub. Date: Dec. 24, 2020

(54) CASH TAGGING AND TRACKING

(71) Applicant: Wells Fargo Bank, N.A., San Francisco, CA (US)

(72) Inventors: Ramanathan Ramanathan, Bellevue, WA (US); Chris Kalaboukis, San Jose, CA (US); Andrew J. Garner, IV, State Road, NC (US); Abhijit Rao, Irvine, CA (US); Andres J. Saenz, Redmond, WA (US)

(21) Appl. No.: 15/840,681

(22) Filed: Dec. 13, 2017

Related U.S. Application Data
(60) Provisional application No. 62/440,148, filed on Dec. 29, 2016.

(51) Int. Cl. G06Q 20/10; G06K 19/07

(52) U.S. Cl. CPC G06Q 20/1085; G06Q 20/3278; G06K 19/0723

(57) ABSTRACT

The innovation disclosed and claimed herein, in one aspect thereof, comprises systems and methods of cash tagging. A system enhances an automated teller machine with the capability of depositing a Radio Frequency Identification tag on the paper substrate of the cash. The cash is tagged after determination of a tracking scenario. The cash may be tracked by using an RFID scanner. The cash may be tracked using a remote cash registry to track and record ownership, location, or the like.

### CROSS-REFERENCE TO RELATED APPLICATION

This application claims the benefit of U.S. Provisional Patent Application Ser. No. 62/440,148 entitled “CASH TAGGING AND TRACKING” filed on Dec. 29, 2016. The entirety of the above-noted application is incorporated by reference herein.

### BACKGROUND

People can have difficulties with misplacing cash once it is in their possession. There is a tendency to forget the location where the cash was stored. In some cases, people hide cash in various places about their home and then forget that it is there. Cash, typically paper money, is often difficult to locate and retrieve unless a person knows where the cash has been stored. In particular, there are many documented cases where elderly customers forget where cash is stored, or do not inform their family or caregivers of the location of the cash. In some cases, when a customer passes away, their home could contain large amounts of ‘hidden’ cash that are oftentimes stored in different or peculiar locations.

### BRIEF SUMMARY OF THE DESCRIPTION

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, comprises systems and methods of tagging and tracking items, such as cash. The tagging innovation includes an act of receiving a transfer request for transfer of possession of an item to a receiver and determining if a tracking scenario exists based on the transfer request. The tagging further includes depositing an identifying token onto (or within) an item when a tracking scenario exists and transferring the item to the receiver. The tagging includes associating the item with the identifying token in a database and associating the item with the receiver of the item.

A system of the innovation can include a request component that receives a transfer request for transfer of possession of an item to a customer. The system includes a decision component that determines if a tracking scenario exists based on the transfer request. The system further includes a tag component that tags an item with an identifying token when a tracking scenario exists. The system further includes a transfer component that facilitates the transfer and following of the item to the receiver. A database is employed to associate the item, the identifying token, and the receiver in the database.

An augmented automated teller machine (ATM) of the innovation has computer readable instructions to control one or more processors configured to receive a cash request for dispensation of cash bills to a customer and determine if a tracking scenario exists based on the cash request. The augmented automated teller machine generates a printable radio frequency identification (RFID) tag; and prints (or otherwise embeds) the radio frequency identification tag onto each cash bill. The augmented ATM dispenses the cash bills to the customer; and associates the cash bills with the RFID tags in a database. The augmented ATM can further associate the cash bills with the customer.

In aspects, the subject innovation provides substantial benefits in terms of cash management and security. One advantage resides in a secure knowledge of the location and possession of tagged cash or other tagged items. Another advantage resides in increased ease in locating and tracking hidden cash or other tagged items.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

Aspects of the disclosure are understood from the following detailed description when read with the accompanying drawings. It will be appreciated that elements, structures, etc. of the drawings are not necessarily drawn to scale. Accordingly, the dimensions of the same may be arbitrarily increased or reduced for clarity of discussion, for example.

FIG. 1 illustrates an example system for facilitating tagging, transferring, and tracking items in accordance with aspects of the innovation.

FIG. 2 illustrates an example component diagram of a tag component in accordance with aspects of the innovation.

FIG. 3 illustrates an automated teller machine (ATM) configured to tag cash in accordance with aspects of the innovation.

FIG. 4 illustrates an example component diagram of a location system in accordance with aspects of the innovation.

FIG. 5 illustrates an example method for tagging and transferring items in accordance with aspects of the innovation.

FIG. 6 illustrates an example method for locating tagged items in accordance with aspects of the innovation.

FIG. 7 illustrates a computer-readable medium or computer-readable device comprising processor-executable instructions configured to embody one or more of the provisions set forth herein, according to some embodiments.

FIG. 8 illustrates a computing environment where one or more of the provisions set forth herein can be implemented, according to some embodiments.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, or a computer. By way of illustration, both an application running on a controller and the controller can be a component. One or more components residing within a process or thread of execution and a component may be localized on one computer or distributed between two or more computers.

Furthermore, the claimed subject matter can be implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

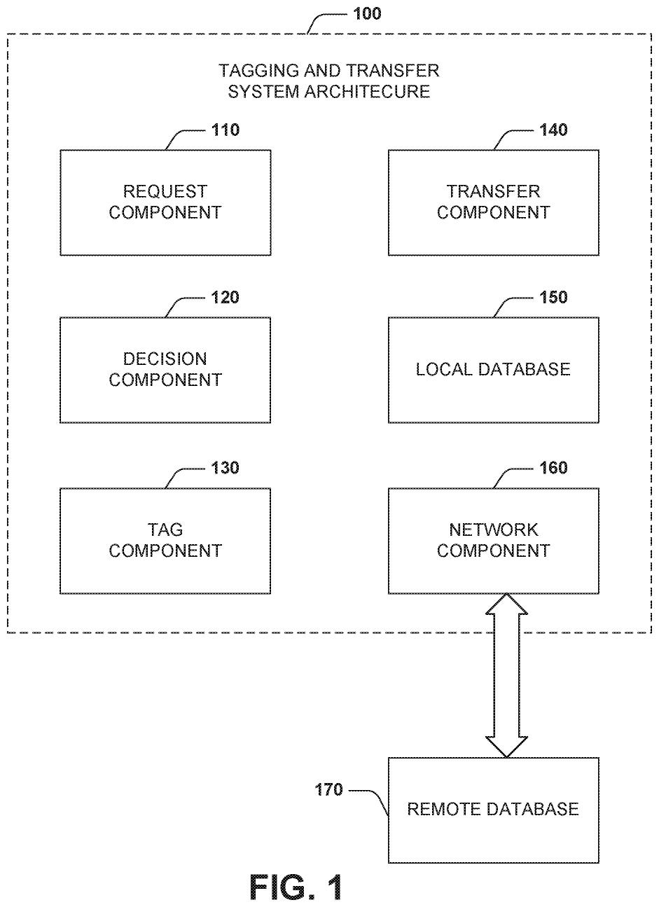

FIG. 1 illustrates an example system 100 that can facilitate tagging, transferring, and tracking items, such as currency. The system 100 includes a request component 110. The request component 110 receives a transfer request to transfer possession of an item to a receiver. The transfer request includes information regarding a transfer of possession of an item. The information can include an indication or description of the item, quantity of the item, intended receiver of the item, information about the receiver of the item, dispenser (or transferor) of the item, and/or the like.

The system 100 includes a decision component 120. The decision component (or logic) 120 determines whether a tracking scenario exists based on the transfer request. The decision component 120 parses the transfer request for information related to the transfer as well as information related to the receiver. The decision component 120 analyzes the information to find triggering information indicative of a tracking scenario. The tracking scenario can be based on the specific transaction requested, the demographic of the receiver, the demographic of the transferor/dispenser, etc. Example tracking scenarios can include: the value of the transfer, age of the receiver, mental state of the receiver, a flagged account of the receiver, mode of transaction (bank or automated teller machine (ATM) withdrawal), location of the transfer, and/or a combination of these scenarios among others.

While specific transfer scenarios are described herein, it is to be understood that alternative scenarios exist. In other words, the specific scenarios included herein are included to provide context to the scope of the features, functions and benefits of the innovation and are not in any way to be interpreted as limiting. As such, these alternative scenarios are to be included within the scope of this specification and claims appended hereto.

Upon the logic or decision component 120 determining a tracking scenario exists, a tag component 130 generates and affixes an identifying token or tag onto (or within) the item to be transferred. In aspects, the identifying token can be generated on an “as needed” basis or be a predetermined set of identifying tokens designated to be used for a particular tracking scenario(s). The tag component 130 can permanently or temporarily tag the item depending on the tracking scenario, receiver preferences, institutional preferences, or the like. The tag component 130 is described in further detail below.

The system 100 includes a transfer component 140. The transfer component 140 can provide or otherwise facilitate transfer or delivery of physical possession of the item to the receiver. In some embodiments, the transfer component 140 provides physical access to and location information about the item for which the receiver can use to pick up. If possession is transferred, in aspects, the transfer component 140 can update a local database 150 with possession information. The local database 150 can store other information about the transfer. For example, the local database 150 can record value of the item, receiver information, tracking scenario detected, receiver flags, and/or the like. In some embodiments, the decision component 120 queries the local database 150 to facilitate determining the tracking scenario.

The system 100 can include a network component 160. The network component 160 can facilitate connection to a mobile network, wired LAN, wireless LAN, an internet network, or the like to transmit communications. The network component 160 connects to a transmission server to send and receive data communications, alerts, or the like to and from the system 100. The mode of the communication can be text, SMS, email, push notification via an API interface, or the like. The network component 160 can update a remote database 170 (e.g., distributed, cloud-based, etc.) with the transfer information, receiver information, item information, and/or the like. The remote database 170 can be accessed by third party entities such as a mobile application (described in detail below), a financial institution, and/or the like.

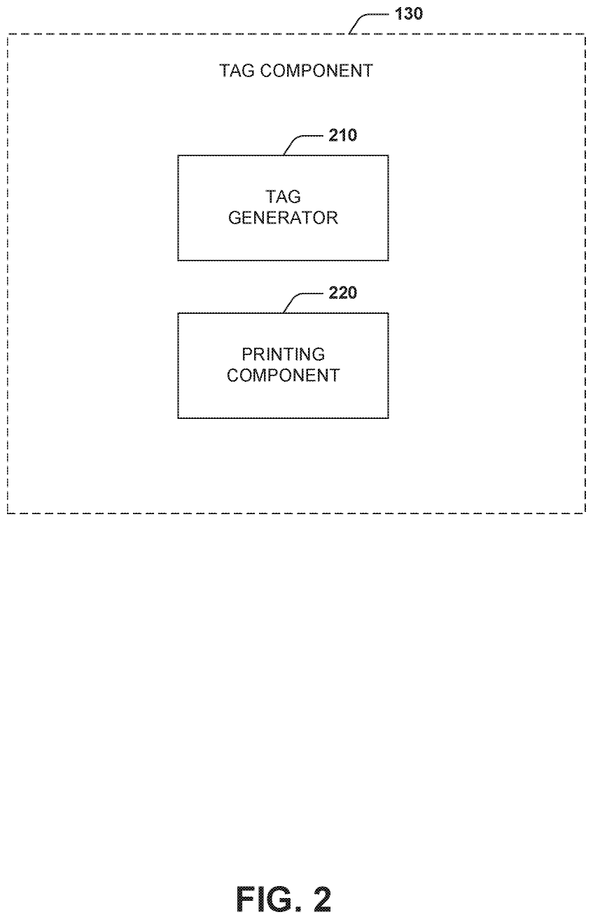

FIG. 2 illustrates an example component diagram of the tag component 130. The tag component 130 includes a tag generator 210. The tag generator 210 can create a unique identifying token or tag which can be affixed to the item upon determination that a tracking scenario exists. It is to be understood that the identifying token is unique to the item, or group of items, to be transferred to the receiver. In aspects, the identifying token is recorded in the local database 150. In some embodiments, the tag generator 210 generates an RFID tag. In other embodiments, the tag generator 210 generates almost any other type of identifying the item, such as a barcode, QR-code (Quick Response code), serial number, and/or the like. In some embodiments, the tag generator 210 generates a plurality of identifying tokens in advance and stores them to be used when a tag is to be affixed.

The tag component 130 includes a printing component 220. The printing component 220 can render printable RFID tags onto items. The printing component 220 can render the identifying tokens permanently or temporarily to the item. In some embodiments, the printing component 200 renders identifying tokens permanently or temporarily based on the tracking scenario. For example, a tracking scenario is triggered based on age of the customer, the tracking scenario may dictate that the item is tagged temporarily. In other embodiments, the tracking scenario is an account with suspicious activity. The tracking scenario may dictate the item is tagged permanently so as to assist in analysis of the suspicious activity.

In some embodiments, the printing component 220 renders the tags using thermal evaporation techniques and/or the like. In this embodiment, a high frequency RFID transponder (tag) is deposited onto the cash bill (acting as a paper substrate) using thermal evaporation.

The RFID transponder can include a coil antenna that consists of a thin aluminum layer evaporated through a masking system. In other embodiments, the RFID tags may be passive, i.e., battery-less. In aspects, the RFID tags can provide a read distance of up to 40 meters in passive mode. In other embodiments, the RFID tags use high frequency or ultra-high frequency tags that can be detected within 0 to 12 meter distances from a RFID reader. It is appreciated that while examples are provided using cash bills as items, almost any physical item may be tagged with a printable RFID tag. For example, a general purpose printer may augmented to be able to detect an important document and thereafter automatically tag the document with an RFID and record associations in a backend system to track location, ownership, and/or the like.

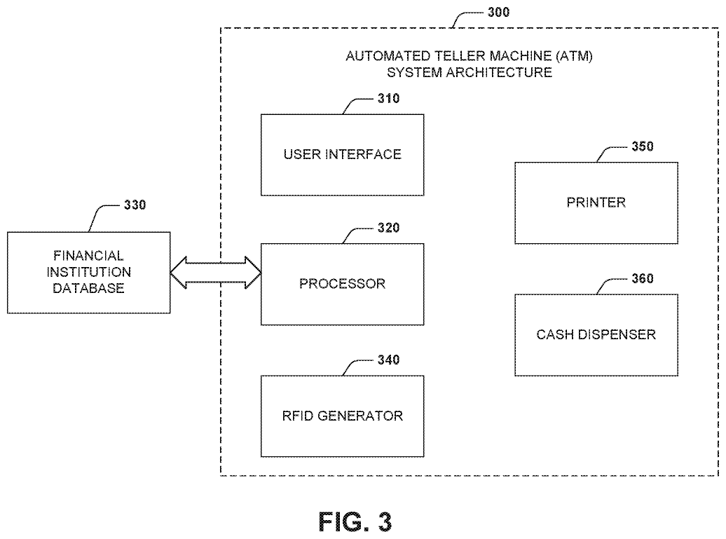

FIG. 3 illustrates an ATM 300 embodiment of the innovation. It is appreciated that the ATM 300 is presented as a specific, non-limiting, example embodiment of the innovation. Other embodiments are contemplated as well and intended to be included within the scope of this disclosure and claims appended hereto. The ATM 300 can be a kiosk, vestibule, integrated machine, and/or the like. The ATM 300 dispenses cash to customers, i.e. receivers. The ATM 300 includes a user interface 310. The user interface 310 can include a display, touchscreen, keypad, or other means to interface with, or receiver input from, a receiver, e.g. a customer. The receiver may employ, communicate with, or otherwise operate the user interface 310 to input a request, e.g., transfer request. The transfer request includes information regarding a transfer of possession of an item. The information can include an indication of the item, quantity of the item, intended receiver of the item, information of the receiver of the item, dispenser of the item, and/or the like.

The ATM 300 includes a processor 320. The processor 320 determines whether a tracking scenario exists based on the transfer request. The processor 320 parses the transfer request for the information related to the transfer and the customer. The processor 320 analyzes the information to find triggering information indicative of a tracking scenario, e.g., cash withdrawal. The tracking scenario can be based on the specific transaction requested, the demographic of the receiver, and/or both. Example tracking scenarios can include the amount of transfer, age of the receiver, mental state of the receiver, a flagged account of the receiver, mode of transaction (bank or ATM withdrawal), location of the transfer, and/or a combination of these scenarios.

The processor 320 facilitates a query of a financial institution database 330. The financial institution database 330 contains account information for customer(s) of a financial institution associated with the customer. The financial institution database 330 can include information to facilitate determining a tracking scenario by the processor 320. In other embodiments, cash may be tagged at a bank teller window. Upon determination that a tracking scenario is appropriate and exists, a bank teller may employ a printer to tag the cash before transferring cash a customer. Thus, the tagged cash can be tracked and located as desired.

Upon the processor 320 determining a tracking scenario exists, an RFID generator 340 generates a identifying token or tag to be affixed to the cash which is thereafter dispensed to the customer. The tag can be generated on an “as needed” basis or be a predetermined set of tags designated to be used for the tracking scenarios. The RFID generator 340 can create a tag to be affixed to the cash upon determination that a tracking scenario exists. The tag is unique to the item, or items, to be transferred to the receiver. In some embodiments, the RFID generator 340 generates a plurality of RFID tags in advance and stores the RFID tags to be used when a tag is to be printed onto the cash bills.

While a specific RFID generator is disclosed and described, it is to be understood that alternative technologies can be employed to tag items (e.g., cash) such as, but not limited to, bar codes, QR-codes, or the like.

The RFID generator 340 establishes and provides the RFID tag data to a printer 350. The printer 350 can render printable RFID tags onto the paper substrate of cash bills. In some embodiments, the printer 350 renders the tags using thermal evaporation techniques and/or the like. The printer 350 can render the tags permanently or temporarily to the item. The printer 350 can permanently or temporarily tag the item depending on the tracking scenario or receiver preferences or intuitional preferences.

The printer 350 provides the tagged cash bills to a cash dispenser 360. The cash dispenser 360 dispenses the cash bills to the customer. In some embodiments, the cash dispenser 360 provides physical access to the cash for which the customer to pick up. In some embodiments, the cash dispenser 360 counts the cash bills and records the amount in the financial institution database along with the corresponding RFID tags for each bill. This information can be stored locally, transmitted, stored remotely, and/or the like.

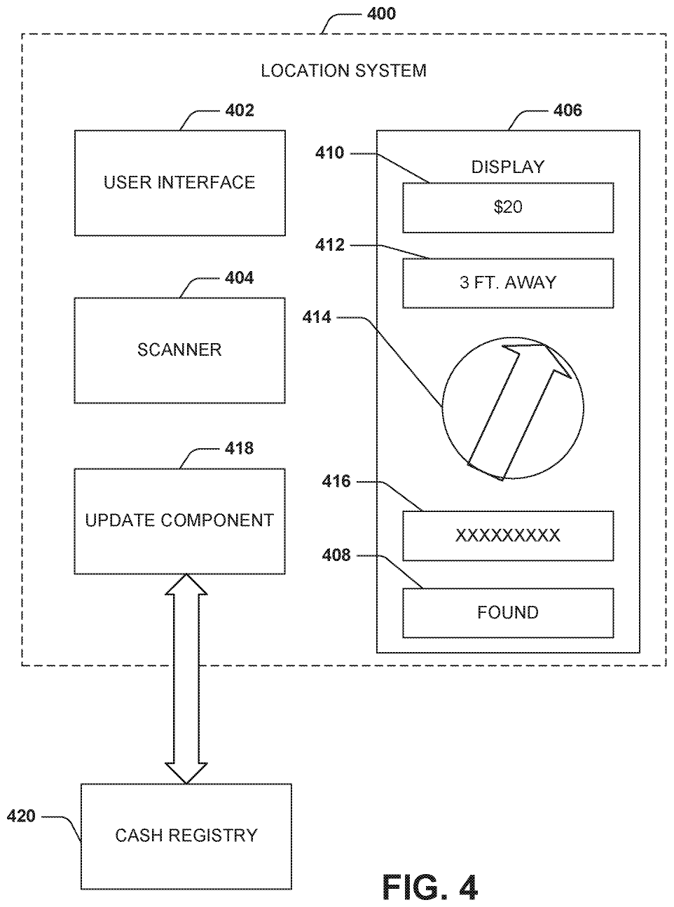

FIG. 4 illustrates an example location system 400 in accordance with aspects of the innovation. The location system 400 facilitates locating tagged items. The location system 400 can locate tagged items within a predetermined range. In some embodiments, the location system 400 is a mobile device such as a smart phone, smart watch, tablet, computer, and/or the like.

The location system 400 includes a graphical user interface (GUI) 402. The GUI 402 provides an interface with which a user may interact to locate tagged items. A user can initiate a location scan with the GUI 402. The GUI 402 can communicate with and activate a scanner 404. The scanner 404 and associated logic can prompt determination of the location of tagged items. In operation, the scanner 404 reads or analyzes presence within an area (e.g., the immediate area) for tagged items. In some embodiments, if the scanner 404 detects a tagged item, the scanner 404 analyzes and reads the tag for the information about the tagged item. For example, if the scanner 404 detects a RFID tagged cash bill, the scanner 404 can read the RFID for information such as amount, serial number, transfer date, and/or the like. In some embodiments, the scanner 404 is a long field RFID reader.

The location system 400 includes a display 406. The display 406 can provide information regarding detected tagged items. The information can include a found/not-found toggle 408, a denomination field 410, a distance field 412, a direction indicator 414, a unique identifier field 416, and/or the like. The direction indicator 414 can include an arrow swivel that updates as the location system 400 is moved in relation to the tagged item. The found/not-found toggle 408 can be operated by the user to indicate whether the right item has been detected. The user can indicate to the location system 400 and scanner 404 that this specific item has been found, and the scanner will disregard that tag and search for others in the immediate area.

The location system 400 includes an update component 418. The update component 418 can update a cash registry 420 (locally or remotely). The cash registry 420 maintains an accurate inventory of items in possession of the user. The update component 418 can update the cash registry 420 over a network. In some embodiments, subsequent transfers may be recorded by the location system 400 and the update component 418 updates a subsequent owner of the tagged cash in the cash registry 420.

Still further embodiments of the location system are contemplated. In some embodiments, a location system is used to detect cash that has been tagged during the initial printing of the cash by a governmental entity. In another embodiment, a location system can be used to efficiently count stacks of tagged cash within a range of the location system. In yet another embodiment, the location system 400 and cash registry 420 can be used for theft detection or ownership verification. For example, the location system 400 may detect a tagged item and then verify that the owner of the location system 400 matches to listed owner in the cash registry 420. In another embodiment, the location system 400 may be used for other items such as art pieces, important documents, and/or the like.

In yet other aspects, tagged items or cash can be actively monitored so as to protect ownership and provide location data. In one example, an alert or notification can be sent to an owner or other designated entity upon detection of a change in physical location of an item or cash. In this example, active monitoring can be established via a static, stationary, or mobile device (e.g., smartphone) whereas, upon detection of a change in last known location, an alert (SMS, email, MMS, auditory, visual, vibratory, etc.) can be sent to an owner and/or other designated entity (e.g., care giver, legal authority, etc.). These and other monitoring/tracking scenarios are to be included within the scope of the innovation and claims appended hereto.

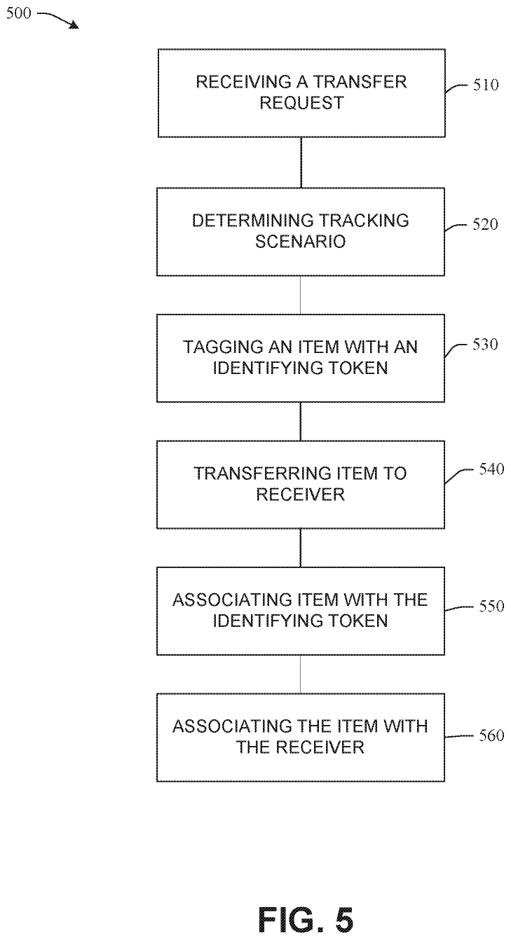

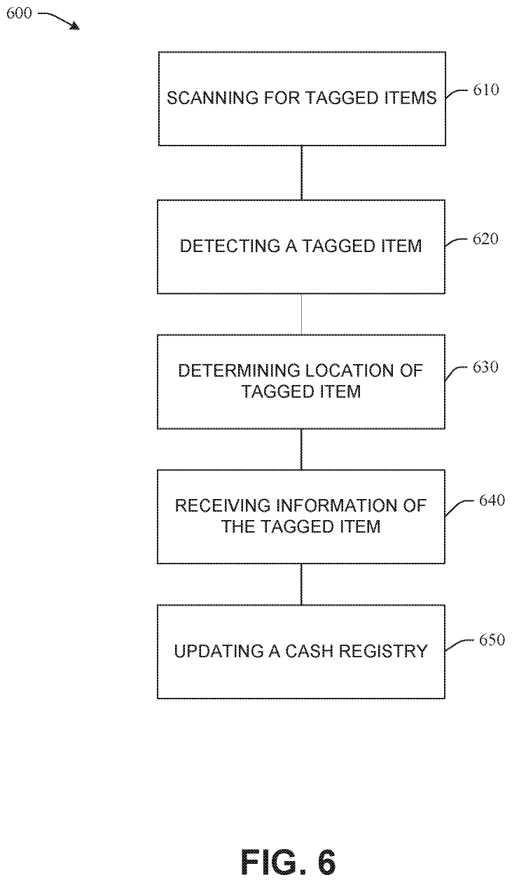

With reference to FIG. 5 and FIG. 6, example methods 500 and 600 are depicted for item tagging and location discovery. While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation. It is also appreciated that the method 500 and 600 are described in conjunction with a specific example is for explanation purposes.

FIG. 5 illustrates a method 500 for tagging an item. In aspects, method 500 can begin at 510 by receiving a transfer request for transfer of possession of an item to a receiver. For example, an ATM receives a withdrawal request from a customer (receiver) for $100 in five twenty-dollar bills. The request can be input via the ATM's user interface which may include a touch screen, keypad, or almost any other user interface, or the like. The transfer request can include information of item(s), receiver information, and/or the like. In some embodiments, the transfer request is received after first authenticating the customer through almost any authentication means.

At 520, a tracking scenario is determined based on the transfer request. Continuing the example, the ATM parses the information in the withdrawal request and the customer account information for triggers that determine a tracking scenario exists. In this example, the ATM recognizes the age of the customer as above a threshold, e.g. the customer is 80 years of age and a tracking scenario is triggered for withdrawals by customers over the age of 70 years. Other triggers, e.g. thresholds, can be amount of the withdrawal, a flagged customer account, a distress code entered by the customer, a determination of the customer's emotional state, a combination of triggers, and/or the like.

At 530, upon determining a tracking scenario exists, the item to be transferred is tagged with an identifying token. At 540, the tagged item(s) is transferred to the receiver. In the example, the ATM is capable of printing, or affixing, an RFID tag onto each twenty-dollar bill before dispensing the bills to the customer. In some embodiments, the ATM may generate an RFID tag for each bill or the same tag for each bill. In other embodiments, the ATM may use pre-generated RFID tags. The ATM can print the RFID tags using thermal printing techniques or the like. At 550, the identifying item is associated with the identifying token. At 560, the item is associated with the receiver. In the example, the ATM can record the cash bills as possessed by the customer via the specific RFID tags that are associated with each cash bill.

FIG. 6 illustrates a method 600 for locating tagged items. In aspects, method 600 can begin at 610 by scanning an immediate area for tagged items. For example, a mobile device has an app installed for searching for tagged items. The mobile device includes means for searching for tagged items. At 620, a tagged item is detected. In the example, tagged cash bills are hidden in a closet. The mobile device detects the tagged cash bills when within a predetermined radius of the tagged cash bills. At 630, the location of the tagged items is determined. In the example, the mobile device can determine distance of the cash from the mobile device and the direction from the mobile device to the cash.

At 640, information of the tagged item is received. In the example, the mobile device can read the RFID tag on the cash bills to retrieve information about the cash such as denomination, recorded possessor, and/or the like. In some embodiments, the mobile device will check the possessor information against the owner of the mobile of device. The mobile device will only locate the cash for possessors of the cash, relatives of the possessor, and/or authorized users to locate the cash. At 650, a cash registry is updated. In the example, the mobile device can update the cash registry with information such as location of the cash found, and/or the like.

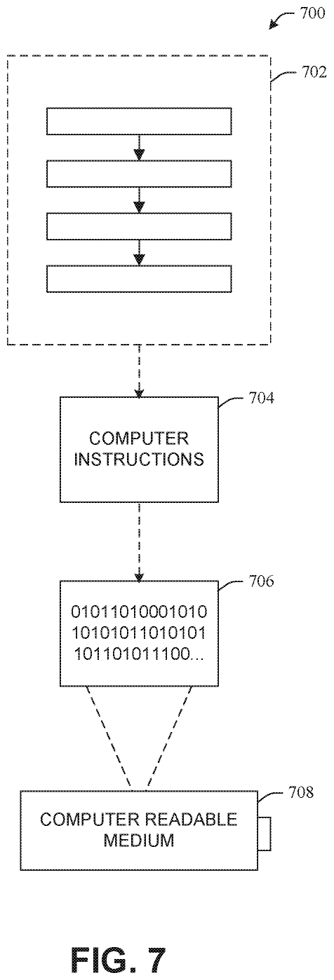

Still another embodiment can involve a computer-readable medium comprising processor-executable instructions configured to implement one or more embodiments of the techniques presented herein. An embodiment of a computer-readable medium or a computer-readable device that is devised in these ways is illustrated in FIG. 7, wherein an implementation 700 comprises a computer-readable medium 708, such as a CD-R, DVD-R, flash drive, a platter of a hard disk drive, etc., on which is encoded computer-readable data 706. This computer-readable data 706, such as binary data comprising a plurality of zero's and one's as shown in 706, in turn comprises a set of computer instructions 704 configured to operate according to one or more of the principles set forth herein. In one such embodiment 700, the processor-executable computer instructions 704 is configured to perform a method 702, such as at least a portion of one or more of the methods described in connection with embodiments disclosed herein. In another embodiment, the processor-executable instructions 704 are configured to implement a system, such as at least a portion of one or more of the systems described in connection with embodiments disclosed herein. Many such computer-readable media can be devised by those of ordinary skill in the art that are configured to operate in accordance with the techniques presented herein.

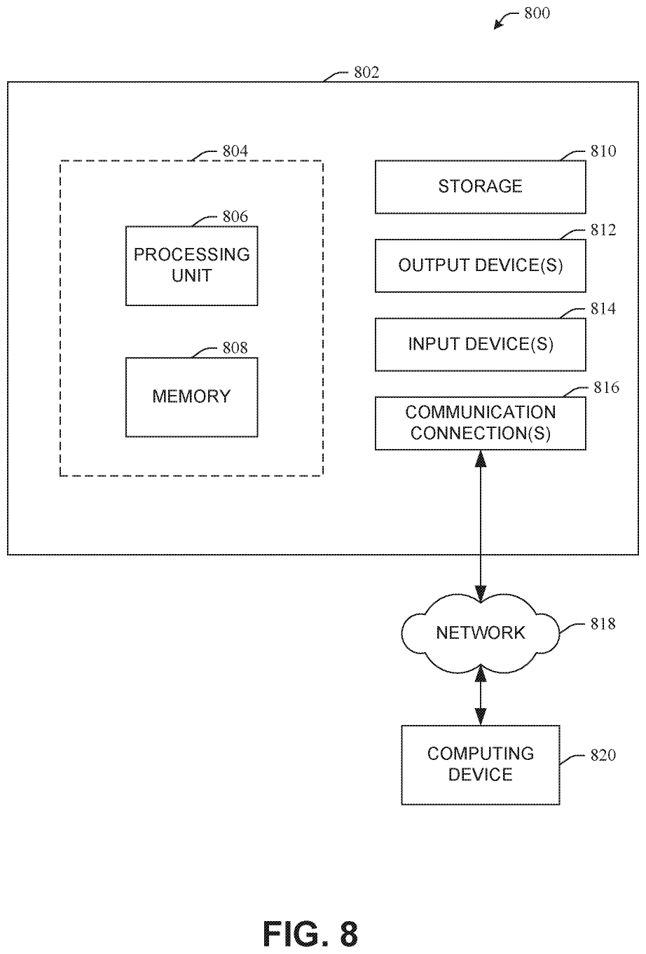

With reference to FIG. 8 and the following discussion provide a description of a suitable computing environment in which embodiments of one or more of the provisions set forth herein can be implemented. The operating environment of FIG. 8 is only one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, tablets, and the like, multiprocessor systems, consumer electronics, mini computers, mainframe computers, distributed computing environments that include any of the above systems or devices, and the like.

Generally, embodiments are described in the general context of “computer readable instructions” being executed by one or more computing devices. Computer readable instructions are distributed via computer readable media as will be discussed below. Computer readable instructions can be implemented as program modules, such as functions, objects, Application Programming Interfaces (APIs), data structures, and the like, that perform particular tasks or implement particular abstract data types. Typically, the functionality of the computer readable instructions can be combined or distributed as desired in various environments.

FIG. 8 illustrates a system 800 comprising a computing device 802 configured to implement one or more embodiments provided herein. In one configuration, computing device 802 can include at least one processing unit 806 and memory 808. Depending on the exact configuration and type of computing device, memory 808 may be volatile, such as RAM, non-volatile, such as ROM, flash memory, etc., or some combination of the two. This configuration is illustrated in FIG. 8 by dashed line 804.

In these or other embodiments, device 802 can include additional features or functionality. For example, device 802 can also include additional storage such as removable storage or non-removable storage, including, but not limited to, magnetic storage, optical storage, and the like. Such additional storage is illustrated in FIG. 8 by storage 810. In some embodiments, computer readable instructions to implement one or more embodiments provided herein are in storage 810. Storage 810 can also store other computer readable instructions to implement an operating system, an application program, and the like. Computer readable instructions can be accessed in memory 808 for execution by processing unit 806, for example.

The term “computer readable media” as used herein includes computer storage media. Computer storage media includes volatile and nonvolatile, non-transitory, removable and non-removable media implemented in any method or technology for storage of information such as computer readable instructions or other data. Memory 808 and storage 810 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 802. Any such computer storage media can be part of device 802.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

Device 802 can include one or more input devices 814 such as keyboard, mouse, pen, voice input device, touch input device, infrared cameras, video input devices, or any other input device. One or more output devices 812 such as one or more displays, speakers, printers, or any other output device can also be included in device 802. The one or more input devices 814 and/or one or more output devices 812 can be connected to device 802 via a wired connection, wireless connection, or any combination thereof. In some embodiments, one or more input devices or output devices from another computing device can be used as input device(s) 814 or output device(s) 812 for computing device 802. Device 802 can also include one or more communication connections 816 that can facilitate communications with one or more other devices 820 by means of a communications network 818, which can be wired, wireless, or any combination thereof, and can include ad hoc networks, intranets, the Internet, or substantially any other communications network that can allow device 802 to communicate with at least one other computing device 820.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A method, comprising:
receiving a transfer request for transfer of possession of an item to a receiver;
determining a tracking scenario exists based on the transfer request, wherein the tracking scenario determines an untagged item should be tagged with an identifying token, and wherein the tracking scenario includes at least one of a flagged receiver, account information, location of transfer, or mode of transfer;
tagging the untagged item with the identifying token upon receiving a determination that a tracking scenario exists, wherein tagging the item comprises:
generating a printable radio frequency identification tag; and
printing the radio frequency identification tag onto the item;
transferring the item with the identifying token to the receiver;
associating the item with the identifying token in a database; and
associating the item with the receiver of the item.

2. The method of claim 1, wherein determining the tracking scenario comprises:
analyzing information of the transfer request, wherein the transfer request includes information about the item or the receiver; and
comparing the analyzed information to known tracking scenarios or thresholds.

3. (canceled)

4. The method of claim 1, wherein the item is at least one cash bill dispensed from an automated teller machine.

5. (canceled)

6. The method of claim 1, wherein generating the radio frequency identification tag comprises:
determining whether the radio frequency identification tag should be permanent or removable based at least in part upon the tracking scenario.

7. The method of claim 1, comprising:
determining a subsequent transfer of possession of the item;
recording the subsequent transfer in the database; and
updating possession of the item in the database.

8. The method of claim 1, comprising:
determining a location of the item in the future, wherein determining the location includes:
scanning a physical area for a tag affixed to an item; and
determining a distance or direction to the item based on a scan of the tag.

9. The method of claim 1, wherein the receiver is a customer of a financial institution.

10. A system, comprising:
a processor that executes the following computer executable components stored in a memory:
a request component that receives a transfer request for transfer of possession of an item to a customer;
a decision component that determines a tracking scenario exists based on the transfer request, wherein the tracking scenario includes a flagged receiver, account information, location of transfer, mode of transfer, or valuation of the item;
a tag component that tags an item with an identifying token when a tracking scenario exists, wherein the tagging component tags the item by:
generating a printable radio frequency identification tag; and
printing the radio frequency identification tag onto the item;
a transfer component that transfers the item with the identifying token to the receiver; and
a database that associates the item, the identifying token, and the receiver in a database.

11. The system of claim 10, wherein the decision component is configured to:
analyze information of the transfer request, wherein the transfer request includes information about the item or the receiver; and
compare the analyzed information to known tracking scenarios or thresholds.

12. (canceled)

13. The system of claim 10, wherein the system is an automated teller machine and the item is at least one cash bill.

14. (canceled)

15. The system of claim 10, the tagging component is further configured to:
determine whether the radio frequency identification tag should be permanent or removable based on the tracking scenario.

16. The system of claim 10, comprising:
a mobile device that determines a subsequent transfer of possession of the item; and
the database recording the subsequent transfer and updates possession of the item in the database.

17. The system of claim 10, comprising:
a mobile device that determines a location of the item in the future, wherein determining the location includes:
scanning a physical area for a tag affixed to an item; and
determining a distance or direction to the item based on a scan of the tag.

18. The system of claim 10, wherein the receiver is a customer of a financial institution.

19. An augmented automated teller machine having computer readable instructions to control one or more processors configured to:
receiving a cash request for dispensation of cash bills to a customer;
determining a tracking scenario exists based on the cash request, wherein the tracking scenario includes a flagged customer account, account information, location of transfer, mode of transfer, or valuation of the cash;
generating a printable radio frequency identification tag; and
printing the radio frequency identification tag onto each cash bill;
dispensing the cash bills to the customer;
associating the cash bills with the RFID tags in a database; and
associating the cash bills with the customer.

20. (canceled)

21. The augmented automated teller machine of claim 19, comprising:
wherein the tracking scenario includes at least two of: a flagged customer account, account information, location of transfer, mode of transfer, or valuation of the cash.

22. The augmented automated teller machine of claim 19, comprising:
determining whether the radio frequency identification tag should be permanent or removable based on the tracking scenario.

23. The method of claim 1, comprising:
wherein the tracking scenario includes at least two of: a flagged customer account, account information, location of transfer, mode of transfer, or valuation of the cash.

24. The system of claim 10, comprising:
wherein the tracking scenario includes at least two of: a flagged customer account, account information, location of transfer, mode of transfer, or valuation of the cash.
